(19) United States
(12) Patent Application Publication
(10) Pub. No.: US 2026/0021807 A1
(43) Pub. Date: Jan. 22, 2026

(54) IMAGE PROCESSING BY MEANS OF NEURAL NETWORKS VIA A WORKSPACE WITH GEOMETRIC REFERENCE TO REALITY

(71) Applicant: Robert Bosch GmbH, Stuttgart (DE)

(72) Inventor: Volker Fischer, Renningen (DE)

(21) Appl. No.: 19/246,767

(22) Filed: Jun. 24, 2025

(30) Foreign Application Priority Data
Jun. 25, 2024 (DE) 10 2024 205 923.4

(51) Int. Cl. B60W 30/09; G06V 10/82; G06V 20/58

(52) U.S. Cl. CPC B60W 30/09; G06V 10/82; G06V 20/58

(57) ABSTRACT

A method for processing an input image using a task network trained to produce output with regard to a specified task from a representation of the input image in a workspace. The method includes: representing the input image as a superposition of functions that provide location-dependent contributions to the input image; generating a representation of the input image in a workspace from parameters that characterize this superposition; feeding this representation to the task network so that the task network ascertains the output with regard to the specified task. A method for transforming an input image into a superposition of functions, and a method for training a decomposition network for use in the method, are also described.

### CROSS REFERENCE

The present application claims the benefit under 35 U.S.C. § 119 of German Patent Application No. DE 10 2024 205 923.4 filed on Jun. 25, 2024, which is expressly incorporated herein by reference in its entirety.

### FIELD

The present invention relates to image processing by means of neural networks, which is used, for example, in the context of environmental monitoring of vehicles or robots.

### BACKGROUND INFORMATION

The at least partially automated driving of vehicles and/or robots on company premises or even in public transport requires continuous monitoring of the environment of the vehicle and/or robot. An essential part of the material used for this monitoring consists of images taken from different perspectives. The images are analyzed by means of neural networks with regard to a specified task. If such a neural network has been trained to a sufficient extent, it can generalize well to images and situations unseen during training. This imitates the learning process of human drivers, which can drive on their own after only several tens of hours of driver training and less than 1000 km of driving distance and can handle most situations.

Many neural networks used in this context first apply one or more convolutional layers to transform an input image into a workspace of feature maps that have a significantly lower dimensionality than the original input image. For example, in a cascade of feature maps, the first feature maps may contain basic features and later feature maps may contain more complex features composed of the basic features. A downstream task network applied to the feature maps solves the actual specified task.

### SUMMARY

In a first aspect, the present invention provides a method for processing an input image by means of a task network. This task network is trained to produce output with regard to a specified task from a representation of the input image in a workspace.

According to an example embodiment of the present invention, as part of this method, the input image is represented as a superposition of functions that provide location-dependent contributions to the input image. A representation of the input image is generated in a workspace from parameters that characterize this superposition. This representation is fed to the task network so that the task network ascertains the output with regard to the specified task.

Since the representation in the aforementioned new workspace consists of parameters that characterize a superposition of respective location-dependent functions, these parameters each obtain a location reference. That is to say, the parameters are significantly less abstract than, for example, the entries of the aforementioned feature maps in which a location reference can only be constructed indirectly via the so-called receptive field. That is to say, the representations in this workspace in themselves have a clearer meaning than, for example, representations in the space of the feature maps.

On the one hand, this has the effect that better preparatory work is done for the task network. Many specified tasks benefit from information with geometric reference in the representations. For example, if object instances are to be classified, geometric shapes are an important source of information regarding the type of the object. The better the information in the representations is therefore prepared for the work of the task network, the easier the task becomes for the task network and the easier the training of this task network becomes. The task network is usually trained in a supervised manner. For this purpose, training examples labeled with target outputs are required. This labeling is a manual process and therefore expensive. On the other hand, a network that generates the representation in the new workspace can also be trained in an unsupervised manner, i.e., with unlabeled training examples. This is discussed in more detail in a separate aspect of the present invention.

On the other hand, the representation in the new workspace can also be independently checked for plausibility since it has a clearer semantic meaning. If the end result provided by the task network is unsatisfactory for whatever reason, the reason may be in the processing on the task network but also in the representation used by this task network. If this representation is already erroneous, there is no need to search for errors in the task network.

For this plausibility check, the superposition is compared with the input image in a particularly advantageous embodiment. Further processing of the superposition and/or of parameters that characterize this superposition is then tied to the condition that the superposition is in line with the input image according to a specified criterion.

In a particularly advantageous example embodiment of the present invention, a task network is selected that is trained, in a three-dimensional space from the measurement-based observation of which the input image was obtained,
to identify which areas are occupied by objects, and/or
to detect object instances.

As explained above, representations containing geometric features, such as shapes, are advantageous for these tasks. For example, depth information may in particular decide whether certain image features indicate printed roadway markings, texture changes of the roadway, or objects protruding from the roadway.

In a further particularly advantageous example embodiment of the present invention, a task network is selected that is trained to assign classification scores with regard to one or more classes of a specified classification to the input image, to a portion of the input image, and/or to at least one object instance in the input image. Geometric features are helpful, in particular in deciding which type of object is present.

In a further particularly advantageous example embodiment of the present invention, a control signal is formed from the output provided by the task network. This control signal is used to control a vehicle, a driving assistance system, a robot, a system for quality control, a system for monitoring areas, and/or a system for medical imaging. Since the representation in the new workspace, which is spanned by the functions with location-dependent contributions to the input image, is more suitable for further processing by means of the task network, the probability is increased that the response of the particular controlled technical system to the control signal of the operating situation, represented by the input image, of the particular technical system is appropriate. For this purpose, the input image may, for example, in particular have been captured by means of one or more sensors.

In a further particularly advantageous example embodiment of the present invention, the functions that provide location-dependent contributions to the input image are differentiable, at least with respect to the parameters that characterize the superposition. In this way, the parameters that characterize the superposition can be particularly well optimized along with parameters that characterize the behavior of the task network. For example, for the latter optimization, gradient-based optimization methods, such as stochastic gradient descent, are considered the method of choice. The parameters that characterize the superposition can then be seamlessly added to this optimization. They can be optimized directly for a particular input image, or parameters of a neural decomposition network which itself generates the parameters of the superposition from the input image can be optimized.

In a further particularly advantageous example embodiment of the present invention, the parameters that characterize the superposition include
parameters that characterize the behavior of individual functions,
parameters that characterize the type and/or strength of the effect of individual functions on the image generated by the superposition, and
parameters that characterize the relative weighting of multiple functions relative to one another.

For example, certain parameters may characterize the extent to which functions are shifted, rotated, or compressed along one or more coordinate axes. For example, the type and/or strength of the effect of individual functions may be determined by parameters that define the colors and/or the opacity with which the location-dependent contributions of the functions are transferred into the superposition. For example, parameters that characterize the relative weighting of multiple functions relative to one another may be coefficients of a linear combination or other aggregation.

In a particularly advantageous example embodiment of the present invention, at least one distribution function that assigns a measure of a probability to each location in the input image is selected as a function that provides location-dependent contributions to the input image. These contributions are particularly well interpretable and also motivatable. The representations composed of such contributions in themselves therefore have a meaning that can be further evaluated particularly well by a downstream task network.

An example of such a distribution function is a probability density function of a Gaussian distribution, also often referred to in short as a Gaussian function. Such a function may, for example, be characterized by
three parameters for the spatial shift in the three coordinate directions of the Cartesian space,
three parameters for the scaling in these three coordinate directions,
four parameters for the orientation of the function in space,
three parameters for indicating the color with which the contribution of the function has an effect in the superposition, in the three additive primary colors red, green, and blue, and
optionally additionally velocity vectors for translation and/or rotation.

All of these parameters are in the arguments of sinus, cosine, or an exponential function. The Gaussian function is therefore easily differentiated with respect to these parameters.

In a second aspect, the present invention provides a method for transforming an input image into a superposition of functions that provide location-dependent contributions to the input image.

According to an example embodiment, as part of this method, a parameterized approach is established for the superposition. The input image is fed to a decomposition network, which outputs parameters of the parameterized approach. The approach provided with the parameters thus ascertained is considered as the superposition sought.

Previously, when decomposing an input image with a parameterized approach of location-dependent functions, the parameters of this approach were optimized directly. In comparison, the training of a decomposition network that ascertains the sought parameters for the parameterized approach from the input image is significantly more complex. On the other hand, the result of this optimization is valid not only for a single input image but also for many unseen input images. After a one-time additional investment in the training of the decomposition network, decompositions of further input images can thus be obtained much faster than if an individual optimization would have to be performed for each input image anew. In particular, for a video sequence of many individual images, decompositions of the individual images can be obtained almost in real time.

Decompositions obtained by means of the method of the present invention described here may, for example, be used, in particular in the method described above, to transform the input image into a representation in a workspace. However, their application is not limited thereto. Rather, the decompositions may, for example, also be used to generate new images based on input images of a scene taken from different perspectives, the new images showing the same scene from a very different perspective.

In a third aspect, the present invention provides a method for training a decomposition network for use in the method described above in connection with the second aspect.

According to an example embodiment of the present invention, as part of this method, a set of training images is provided. These training images are processed into superpositions according to the method described above in connection with the second aspect.

The superpositions thus obtained are compared with the respective training images. A deviation Δ of the superpositions from the respective training images is evaluated by means of a specified cost function (loss function). Parameters that characterize the behavior of the decomposition network are optimized with the aim that the evaluation by the cost function is improved during the further processing of training images.

An advantage of this training is that it does not require any training images labeled with respective target outputs of the decomposition network. Instead, any unlabeled training images may be used. These training images are inexpensive to obtain in almost any quantity, while labeling is essentially an expensive manual process.

Furthermore, this reconstruction loss as an optimization objective is also immediately clear. If the objective is to convert a specified input image into a true representation, this representation should contain exactly the information needed to reproduce the original input image as well as possible. This is somewhat analogous to the training of an autoencoder, which squeezes the information of the input through a low-dimensional “bottleneck” and thus forces the encoder to reduce the input to the information that is most important for good reconstruction.

In addition, one or more further optimization objectives may be pursued, which manifest in corresponding contributions to the cost function.

For example, the training images may include a series of temporally consecutive images. The cost function may then additionally measure to what extent the superpositions generated are temporally consistent. For example, such temporal consistency may, in particular, include that the changes from one image to the next image are arranged in the correct order and occur at a speed that matches the temporal distance between the images.

The superpositions can be fed to a task network trained to produce output with regard to a specified task. The cost function may then additionally measure the quality of the output provided by the task network. For example, a cost function suitable for the training of the task network may, in particular, be used for this purpose. For example, the parameters that characterize the behavior of the decomposition network and the parameters that characterize the behavior of the task network may thus, in particular, be jointly optimized end-to-end.

In a further particularly advantageous configuration of the present invention, training parameters are sampled from the space of the parameters that characterize superpositions. These training parameters are inserted into the parameterized approach used for generating superpositions, so that training superpositions are generated. The training superpositions in turn are fed to the decomposition network. This closed path should ideally result in the original sampled training parameters. The cost function therefore additionally measures to what extent the parameters output by the decomposition network are in line with the sampled training parameters. This is a type of reversed reconstruction loss.

The method of the present invention may in particular be fully or partially computer-implemented. The present invention therefore also relates to a computer program comprising machine-readable instructions that, when executed on one or more computers and/or compute instances, cause the computer(s) and/or compute instance(s) to perform one of the described methods of the present invention. In this sense, control devices for vehicles and embedded systems for technical devices that are likewise capable of executing machine-readable instructions are also to be regarded as computers. Compute instances may, for example, be virtual machines, containers, or serverless execution environments, which may in particular be provided in a cloud.

The present invention also relates to a machine-readable data carrier and/or a download product with the computer program. A download product is a digital product that can be transmitted via a data network, i.e., can be downloaded by a user of the data network, and may, for example, be offered for sale in an online shop for immediate download.

Furthermore, one or more computers and/or compute instances may be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 of the present invention for processing an input image 1 by means of a task network 6.

FIG. 2 shows an exemplary embodiment of the method 200 of the present invention for transforming an input image 1 into a superposition 5 of functions that provide location-dependent contributions 5a to the input image 1.

FIG. 3 shows an exemplary embodiment of the method 300 of the present invention for training a decomposition network 8.

### DETAILED DESCRIPTION OF EXAMPLE EMBODIMENTS

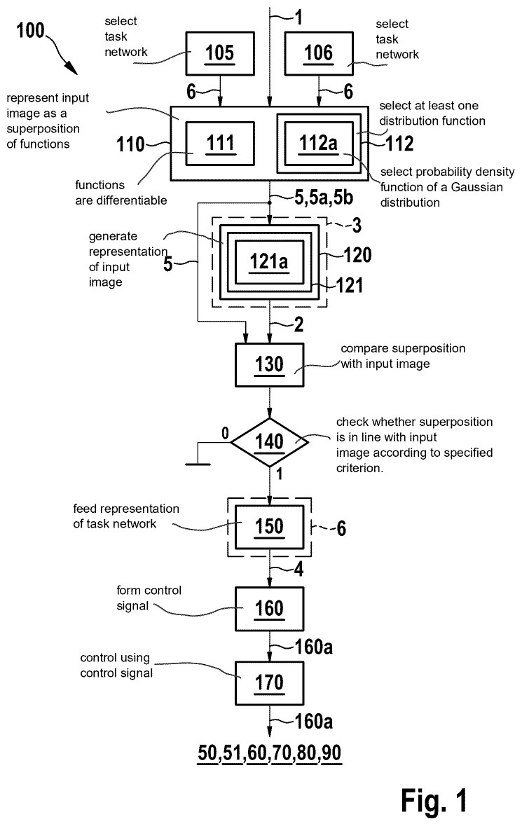

FIG. 1 is a schematic flowchart of an exemplary embodiment of the method 100 for processing an input image 1 by means of a task network 6. The task network 6 is trained to produce output 4 with regard to a specified task from a representation 2 of the input image 1 in a workspace 3.

According to block 105, a task network 6 can be selected that is trained, in a three-dimensional space from the measurement-based observation of which the input image 1 was obtained,
to identify which areas are occupied by objects, and/or
to detect object instances.

According to block 106, a task network 6 can be selected that is trained to assign classification scores with regard to one or more classes of a specified classification to the input image 1, to a portion of the input image 1, and/or to at least one object instance in the input image 1.

In step 110, the input image 1 is represented as a superposition 5 of functions that provide location-dependent contributions 5a to the input image 1.

According to block 111, the functions that provide location-dependent contributions 5a to the input image 1 can be differentiable, at least with respect to the parameters 5b that characterize the superposition 5.

According to block 112, at least one distribution function that assigns a measure of a probability to each location in the input image 1 can be selected as a function that provides location-dependent contributions 5a to the input image 1. For example, according to block 112a, this distribution function may, in particular, be a probability density function of a Gaussian distribution.

In step 120, a representation 2 of the input image is generated in a workspace 3 from parameters 5b that characterize the superposition 5.

According to block 121, the parameters 5b that characterize the superposition 5 may include
parameters (5b) that characterize the behavior of individual functions,
parameters (5b) that characterize the type and/or strength of the effect of individual functions on the image generated by the superposition (5), and parameters (5b) that characterize the relative weighting of multiple functions relative to one another.

According to block 121a, parameters 5b that characterize the colors and/or the opacity of the contribution of a function to the input image 1 can be selected as parameters 5b that characterize the type and/or strength of the effect of this function on the image generated by the superposition.

In the example shown in FIG. 1, in step 130, the superposition 5 is compared with the input image 1. In step 140, it is then checked whether the superposition 5 is in line with the input image 1 according to a specified criterion, i.e., for example, is sufficiently similar to the input image 1. If this is the case (truth value 1), further processing of the superposition 5 and/or of parameters 5b that characterize this superposition 5 and/or of the representation 2 can be performed.

For example, this further processing may, in particular, comprise that the representation 2 is fed to the task network 6 in step 150 so that the task network 6 ascertains the output 4 with regard to the specified task.

In the example shown in FIG. 1, in step 160, a control signal 160a is formed from the output 4 provided by the task network 6. In step 170, a vehicle 50, a driver assistance system 51, a robot 60, a system 70 for quality control, a system 80 for monitoring areas, and/or a system 90 for medical imaging is controlled with the control signal 160a.

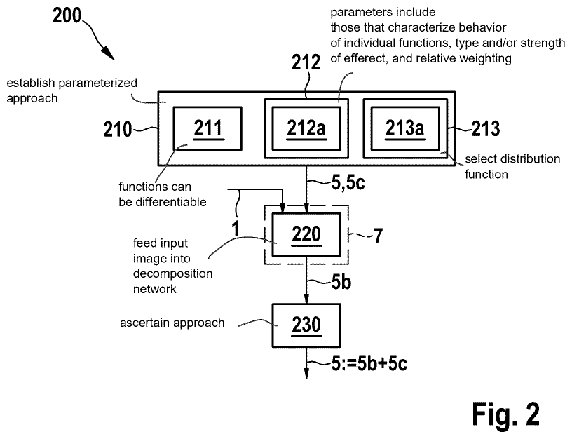

FIG. 2 is a schematic flowchart of an exemplary embodiment of the method 200 for transforming an input image 1 into a superposition 5 of functions that provide location-dependent contributions 5a to the input image 1. For example, this method may, in particular, be used to generate representations 2 of input images 1 in the workspace 3 as part of the method 100 described above.

In step 210, a parameterized approach 5c for the superposition 5 is established.

According to block 211, analogously to block 111, the functions that provide location-dependent contributions 5a to the input image 1 can be differentiable, at least with respect to the parameters 5b that characterize the superposition 5.

According to block 212, analogously to block 121, the parameters 5b that characterize the superposition 5 may include
parameters 5b that characterize the behavior of individual functions,
parameters 5b that characterize the type and/or strength of the effect of individual functions on the image generated by the superposition (5), and
parameters 5b that characterize the relative weighting of multiple functions relative to one another.

Here, according to block 212a, analogously to block 121a, parameters 5b that characterize the colors and/or the opacity of the contribution of a function to the input image 1 can be selected as parameters 5b that characterize the type and/or strength of the effect of this function on the image generated by the superposition.

According to block 213, analogously to block 112, at least one distribution function that assigns a measure of a probability to each location in the input image 1 can be selected as a function that provides location-dependent contributions 5a to the input image 1. For example, according to block 213a, analogously to block 112a, this distribution function may, in particular, be a probability density function of a Gaussian distribution.

In step 220, the input image 1 is fed to a decomposition network 7, which outputs parameters 5b of the parameterized approach 5c.

In step 230, the approach 5c provided with the parameters 5b thus ascertained is considered as the superposition 5 sought.

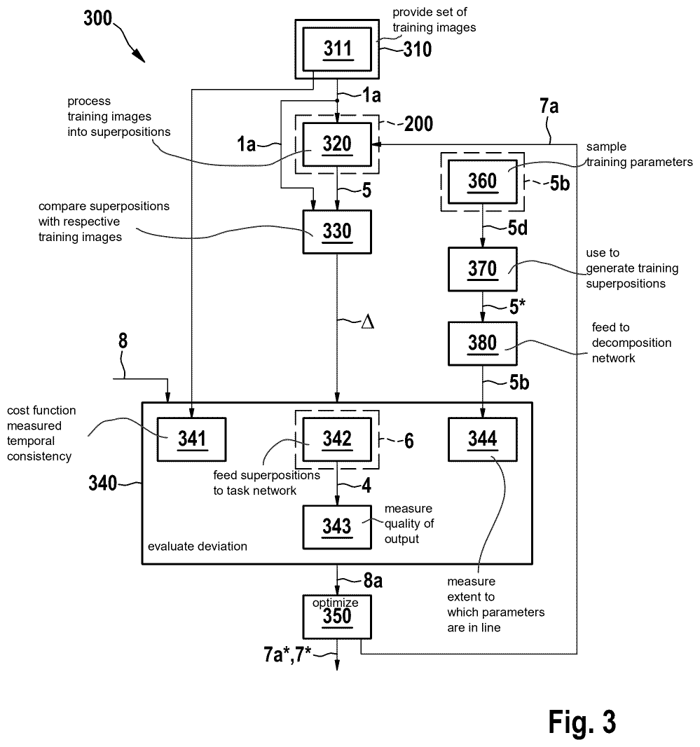

FIG. 3 is a schematic flowchart of an exemplary embodiment of the method 300 for training a decomposition network 7 for use in the method 200 described above.

In step 310, a set of training images 1a is provided.

According to block 311, the training images 1a may include a series of temporally consecutive images.

In step 320, the training images 1a are processed into superpositions 5 by means of the method described above.

In step 330, these superpositions 5 are compared with the respective training images 1a. Here, a deviation 4 of the superpositions 5 from the respective training images 1a is ascertained.

In step 340, this deviation A is evaluated by means of a specified cost function 8. An evaluation 8a is created.

Insofar as the training images 1a according to block 311 include a series of temporally consecutive images, according to block 341, the cost function 8 can additionally measure to what extent the generated superpositions 5 are temporally consistent.

According to block 342, the superpositions 5 can additionally be fed to a task network 6 trained to produce output 4 with regard to a specified task. The cost function 8 can then additionally measure the quality of the output 4 provided by the task network 6. (Block 343).

In the example shown in FIG. 3, in step 360, training parameters 5d can be sampled from the space of the parameters 5b that characterize superpositions 5. By inserting them into the parameterized approach 5c, these training parameters 5d can be used in step 370 to generate training superpositions 5*. These training superpositions 5* can be fed to the decomposition network 7 in step 380. The cost function 8 can then additionally measure, according to block 344, to what extent the parameters 5b output by the decomposition network 7 are in line with the sampled training parameters 5d.

In step 350, parameters 7a that characterize the behavior of the decomposition network 7 are optimized with the aim of improving the evaluation 8a by the cost function 8 during the further processing of training images 1a. The fully optimized state of the parameters 7a is denoted by reference sign 7a*. This state 7a* of the parameters 7a defines the fully trained state 7* of the decomposition network 7.

What is claimed is:

1. A method for processing an input image using a task network trained to produce output with regard to a specified task from a representation of the input image in a workspace, the method comprising the following steps:
representing the input image as a superposition of functions that provide location-dependent contributions to the input image;
generating a representation of the input image in a workspace from parameters that characterize the superposition; and
feeding the representation to the task network so that the task network ascertains the output with regard to the specified task.

2. The method according to claim 1, wherein the task network is selected that is trained, in a three-dimensional space from the measurement-based observation of which the input image was obtained,
to identify which areas are occupied by objects, and/or
to detect object instances.

3. The method according to claim 1, wherein the task network is selected that is trained to assign classification scores with regard to one or more classes of a specified classification to the input image: (i) to a portion of the input image, and/or (ii) to at least one object instance in the input image.

4. The method according to claim 1, wherein:
a control signal is formed from the output provided by the task network, and
a vehicle and/or a driver assistance system and/or a robot and/or a system for quality control and/or a system for monitoring areas and/or a system for medical imaging, is controlled with the control signal.

5. A method for transforming an input image into a superposition of functions that provide location-dependent contributions to the input image, the method comprising the following steps:
establishing a parameterized approach for the superposition;
feeding the input image to a decomposition network, which outputs parameters of the parameterized approach; and
considering the approach provided with the ascertained parameters as the superposition.

6. The method according to claim 5, wherein:
the superposition is compared with the input image, and
further processing of the superposition and/or of parameters that characterize the superposition and/or of the representation is tied to a condition that the superposition is line with the input image according to a specified criterion.

7. The method according to claim 1, wherein the functions that provide location-dependent contributions to the input image are differentiable, at least with respect to the parameters that characterize the superposition.

8. The method according to claim 1, wherein the parameters that characterize the superposition include:
parameters that characterize behavior of individual functions,
parameters that characterize a type and/or strength of an effect of individual functions on the image generated by the superposition, and
parameters that characterize a relative weighting of multiple functions relative to one another.

9. The method according to claim 8, wherein parameters that characterize colors and/or opacity of the contribution of a function to the input image are selected as parameters that characterize the type and/or strength of the effect of the function on the image generated by the superposition.

10. The method according to claim 1, wherein at least one distribution function that assigns a measure of a probability to each location in the input image is selected as a function that provides location-dependent contributions to the input image.

11. The method according to claim 10, wherein at least one probability density function of a gauss distribution is selected as the distribution function.

12. A method for training a decomposition network, comprising the following steps:
providing a set of training images;
processing each of the training images into a respective superposition by:
establishing a parameterized approach for the superposition,
feeding the input image to a decomposition network, which outputs parameters of the parameterized approach, and
considering the approach provided with the ascertained parameters as the superposition;
comparing the superpositions with the respective training images;
evaluating a deviation of the superpositions from the respective training images using a specified cost function; and
optimizing parameters that characterize behavior of the decomposition network, with an aim that the evaluation by the cost function is improved during further processing of training images.

13. The method according to claim 12, wherein:
the training images include a series of temporally consecutive images, and
the cost function additionally measures to what extent the generated superpositions are temporally consistent.

14. The method according to claim 12, wherein:
the superpositions are fed to a task network trained to produce output with regard to a specified task; and
the cost function additionally measures a quality of the output provided by the task network.

15. The method according to claim 12, wherein:
training parameters from a space of the parameters that characterize superpositions are sampled;
the training parameters are used to generate training superpositions;
the training superpositions are fed to the decomposition network; and
the cost function additionally measures to what extent the parameters output by the decomposition network are in line with the sampled training parameters.

16. A non-transitory machine-readable data carrier on which is stored a computer program including machine-readable instructions for processing an input image using a task network trained to produce output with regard to a specified task from a representation of the input image in a workspace, the instructions, when executed by one or more computers and/or compute instances, cause the one or more computers and/or compute instances to perform the following steps:
representing the input image as a superposition of functions that provide location-dependent contributions to the input image;
generating a representation of the input image in a workspace from parameters that characterize the superposition; and
feeding the representation to the task network so that the task network ascertains the output with regard to the specified task.

17. One or more computers and/or compute instances with a non-transitory machine-readable data carrier on which is stored a computer program including machine-readable instructions for processing an input image using a task network trained to produce output with regard to a specified task from a representation of the input image in a workspace, the instructions, when executed by the one or more computers and/or compute instances, cause the one or more computers and/or compute instances to perform the following steps:
representing the input image as a superposition of functions that provide location-dependent contributions to the input image;
generating a representation of the input image in a workspace from parameters that characterize the superposition; and
feeding the representation to the task network so that the task network ascertains the output with regard to the specified task.
